(19) United States
(12) Patent Application Publication
(10) Pub. No.: US 2025/0198932 A1
(43) Pub. Date: Jun. 19, 2025

(54) ADVANCED CRYSTALLIZATION TESTING APPARATUS FOR PIPELINE APPLICATIONS

(71) Applicant: Saudi Arabian Oil Company, Dhahran (SA)

(72) Inventors: Mustafa M. Alsalem, Ar Rawdah (SA); Ali A. Jabran, Dammam (SA)

(21) Appl. No.: 18/543,780

(22) Filed: Dec. 18, 2023

(51) Int. Cl. G01N 21/65; G01N 21/01; G01N 21/17; G01N 21/59

(52) U.S. Cl. CPC G01N 21/65; G01N 2021/0137; G01N 2021/177; G01N 2021/5957

(57) ABSTRACT

An apparatus for advanced crystallization testing (ACT) for pipeline applications is provided. The apparatus includes: a reaction vessel including an open end and a closed end; a removable cap to hermetically seal the open end, the removable cap including a transparent window made of a transparent solid material; a Raman probe facing toward the transparent window and being configured to collect a Raman signal from inside the reaction vessel through the transparent window; an agitation mechanism to agitate contents of the reaction vessel; a bath to house the reaction vessel and maintain a temperature of the reaction vessel at a set temperature.

### TECHNICAL FIELD

This disclosure relates to methods and systems of advanced crystallization testing for pipeline applications.

### BACKGROUND

Production pipelines carrying oil and gas can extend for thousands of kilometers between reservoirs and oil and gas terminals. Solid deposition occurring in the pipelines such as gas hydrates and scales can cause various problems in oil and gas industry. It is thus important to develop technologies to simulate various crystallization phenomena and understand their mechanisms.

### SUMMARY

This disclosure describes technologies relating to advanced crystallization testing apparatus.

### BRIEF DESCRIPTION OF DRAWINGS

FIG. 1 is an advanced crystallization testing (ACT) apparatus including multiple batch reactors.

FIG. 2A is a batch reactor included in an advanced crystallization testing (ACT) apparatus with a removable cap.

FIG. 2B is a batch reactor included in an advanced crystallization testing (ACT) apparatus.

FIG. 3 is a Raman spectrometer system included in an advanced crystallization testing apparatus.

FIG. 4 is an example process flow diagram of a method of advanced crystallization testing.

### DETAILED DESCRIPTION

Implementations described herein provide methods and systems of advanced crystallization testing (ACT). In the oil and gas industry, flow assurance challenges in pipelines are often linked to solid deposition, particularly gas hydrates and inorganic scale formation. Gas hydrates are crystals trapping guest molecules such as methane (CH₄), hydrogen sulfide (H₂S), and carbon dioxide (CO₂) inside a network of host molecules, e.g., water (H₂O). Formations of gas hydrates pose a risk of blockage, corrosion, and operational shutdowns in pipelines, especially those transporting wet sour gas during winter. To prevent hydrate formation, gas production rates are limited, and hydrate inhibitors are used. Scale formation (inorganic salts deposition) issues, on the other hand, may arise in pipelines carrying water-containing products, particularly with high concentrations of inorganic salts. Various scales, such as calcium carbonate or barium sulfate, can precipitate. In some cases, a fluid flow of oil and gas may become partially or completely blocked at certain locations along a production pipeline due to sedimentation of various substances along the pipeline, such as gas hydrates and scale. Accumulation of these substances sometimes results from the combination of a relatively high fluid pressure and a relatively low temperature inside of the pipeline and tends to occur in low-lying sections of the pipeline. Accumulation of the substances may occur over a period of minutes to days and may completely block the fluid flow if left unmitigated. Blockage of the fluid flow can result in costly, delayed arrival of the fluid flow to a final destination.

It is therefore important to understand the phenomena of solid deposition to address the flow assurance challenges in pipelines. To study gas hydrate, pressure-based measurements can be used. However, this method typically requires prolonged experiments to grow crystals to a size large enough to impact the pressure in a reactor. In addition, the current method struggles to detect small or thermally unstable hydrate crystals. For scale formation, lab-based experiments can recreate high saturation conditions. Similar to the gas hydrate characterization, visual inspection and pressure-based measurements are often employed, faced with similar challenges.

The methods and systems of ACT in this disclosure can improve the throughput of crystallization testing by comparatively reducing time and labor required for conducting experiments, particularly for hydrate and scale assessments. Additionally, the use of Raman in various implementations can allow identification of the type of hydrate/scale, which can in turn help in designing new effective hydrate/scale inhibitors.

These improvements can be achieved by implementing an array of lasers for spectroscopic measurements, e.g., Raman spectroscopy. Raman spectroscopy is a technique to observe phase changes and formation of crystals at early stages of crystallization process. The use of spectroscopy allows the identification of hydrate or scale type and enables rapid and detection of crystals at early stages of crystallization. The ACT apparatus can be designed to combine Raman spectroscopy with capability of pressure-based measurements, visual inspection, or both. The methods and systems herein can provide a more robust technique for evaluating hydrate and scale formation and help designing novel hydrate and scale inhibitors for newly emerging harsh environments.

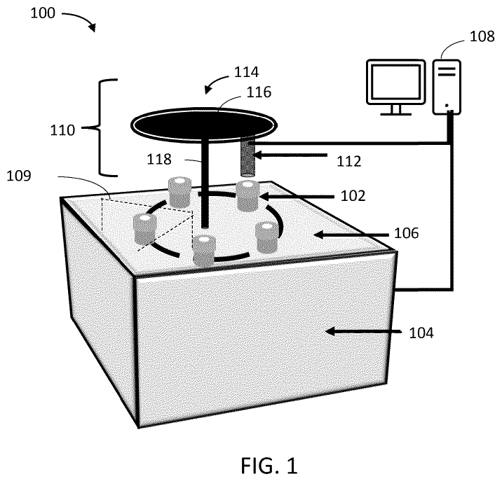

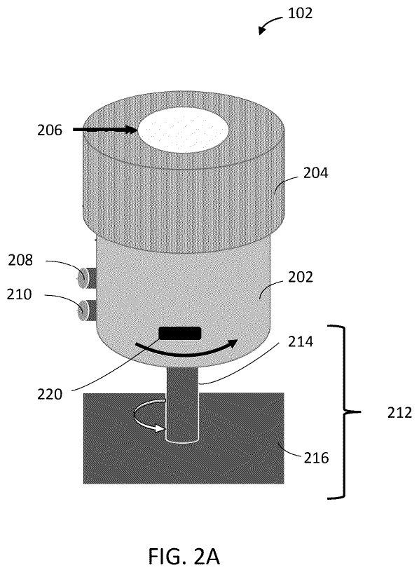

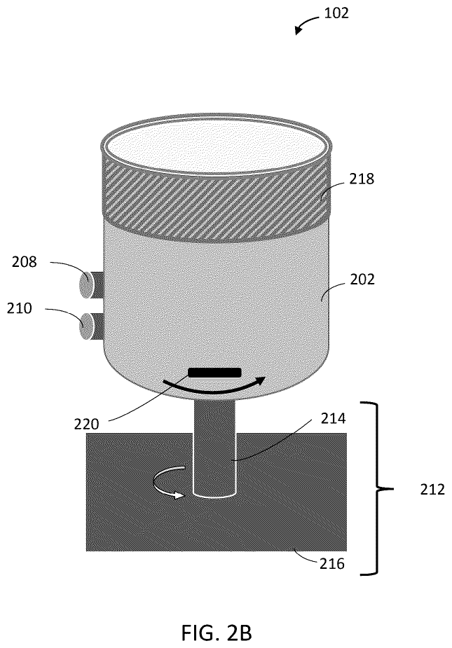

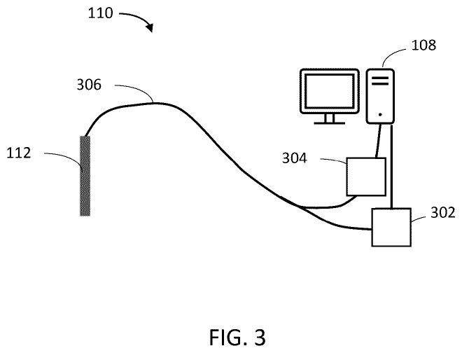

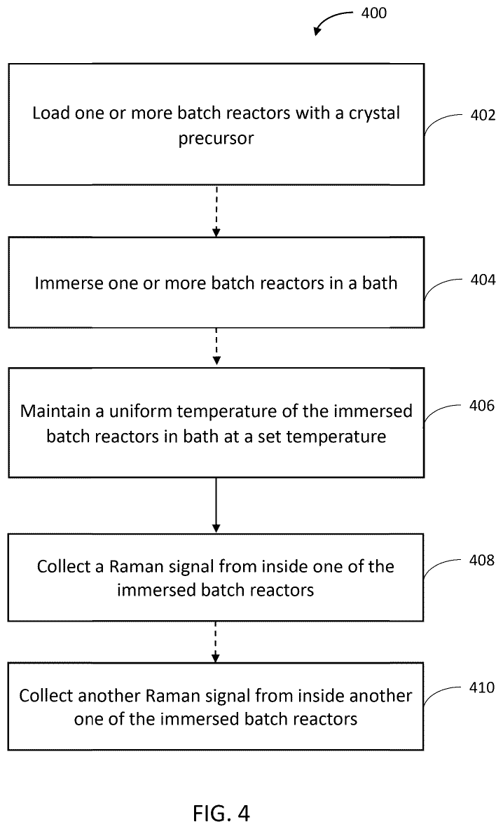

In the following, an overall design of an advanced crystallization testing (ACT) apparatus including multiple batch reactors is described referring to FIG. 1. The details of each bath reactor are then described referring to FIGS. 2A-2B, followed by a Raman spectrometer setup referring to FIG. 3. FIG. 4 is an example flow diagram for the method of crystallization testing.

### Advanced Crystallization Testing Apparatus

FIG. 1 is an example of an advanced crystallization testing (ACT) apparatus 100. In FIG. 1, the ACT apparatus 100 includes one or more batch reactors 102 for performing crystallization testing. In this disclosure, crystallization testing generally refers to any characterization or study of crystallization, solid deposition, or solid formation phenomena. In some implementations, the batch reactors 102 can be designed specifically for study of gas hydrate or scale formation that is of interest in understanding various pipeline issues such as blockage and corrosion.

As illustrated in FIG. 1, the ACT apparatus 100 can have, for example, five batch reactors 102. Generally, hydrate evaluation experiments are laborious, slow, and costly. Providing multiple batch reactors 102 to the ACT apparatus 100 enables performing multiple experiments at once, improving the efficiency and accuracy of crystallization testing. For example, the initial composition of reagents, e.g., host, guest, and inhibitor concentrations, can be varied for different reactors to study the effect of these variables on the crystallization. Further, they can be kept identical between the reactors for duplicating the samples to examine the reproducibility. In some implementations, the ACT apparatus 100 can have any other reasonable number of batch reactors 102. The number of batch reactors 102 can be selected in consideration of the desired throughput of the ACT apparatus 100, the manufacturing cost, and the required space for the batch reactors 102.

The ACT apparatus 100 is equipped with a bath 104 to contain and immerse the batch reactors 102 and maintain a set temperature for the purpose of the crystallization testing. Accordingly, the ACT apparatus 100 can include a temperature controller and necessary components for temperature control. For example, the bath 104 can have insulating walls defining the enclosure volume of the bath 104 and preventing heat loss. The enclosure can be designed to provide a sufficient volume to contain all of the batch reactors 102. The walls can be made of an insulating material, e.g., vacuum insulated panel, silica aerogel, and urea foam.

In some implementations, the bath 104 can be filled with a heat transfer fluid 106 to enable cooling, heating, or both. For example, a glycol, e.g., ethylene glycol, or silicone oil can be used for the heat transfer fluid 106. The heat transfer fluid 106 can be selected to have certain materials properties suitable for target crystallization testing conditions, e.g., a freezing point below 0° C. and a boiling point greater than 100° C. The ACT apparatus 100 can be configured to hold each batch reactor 102 at a same depth in the heat transfer fluid 106 within the bath 104. The set temperature for the batch reactors 102 can be between −5° C. and 100° C. The set temperature can depend on the type of crystallization to be characterized using the ACT apparatus 100. In some implementations, the formation of gas hydrate can be studied at a low temperature, e.g., below 30° C. On the other hand, the scale formation can be separately studied at an elevated temperature, e.g., 35° C. or higher. As further illustrated in FIG. 1, the ACT apparatus 100 is coupled to a computer 108 and the temperature of the bath 104 can be monitored.

In one or more implementations, the bath 104 can have one or more partitions 109 inside to allow further segmentation of heating or cooling zones. Accordingly, the ACT apparatus 100 can have the capability to maintain more than one temperature conditions for different batch reactors 102.

In various implementations, the ACT apparatus 100 includes a Raman spectroscopy system 110 for characterizing the phenomena inside one or more of the batch reactors 102. The Raman spectroscopy system 110 is designed to enable direct and real-time observation of the crystallization phenomena inside the batch reactors 102 without opening them to take out the samples. Using the Raman spectroscopy system 110, the ACT apparatus 100 can directly obtain chemical information about the crystals being formed in the batch reactors 102, which is not accessible by the pressure-based measurements alone. Further, Raman spectroscopy is a robust technique even under the presence of water in the system, providing the method of this disclosure a superior detection capability for different solids at different stages of formation in an aqueous or high moisture systems.

The Raman spectroscopy system 110 can include a Raman probe 112, a Raman moving mechanism 114, and the computer 108. The Raman moving mechanism 114 is configured to move the Raman probe 112 such that the Raman probe 112 can collect a Raman signal from any one of the batch reactors 102. The Raman moving mechanism 114 can be positioned above the batch reactors 102 in a way that the Raman probe 112 can be faced toward any one of the batch reactors 102 for Raman measurements. Using the Raman moving mechanism 114, the ACT apparatus 100 can enable characterizing multiple samples inside different reactors with one Raman probe, e.g., the Raman probe 112, without time-consuming sample preparation for external Raman measurements. In some implementations, as illustrated in FIG. 1, the Raman moving mechanism 114 includes a stage 116 attached to the Raman probe 112 and supported by a central rod 118, where the stage 116 can hold the Raman probe 112 above the batch reactors 102 and rotate around the central rod 118. The stage 116 can be rotated manually or automatically using a motor with a controller.

### Batch Reactor with Agitation Capability

FIG. 2A is an example a batch reactor 102 included in an advanced crystallization testing (ACT) apparatus, e.g., the ACT apparatus 100 in FIG. 1. In FIG. 2A, the batch reactor includes a reaction vessel 202 with a top opening, which can be sealed using a removable cap 204. In various implementations, the reactor vessel 202 has a volume between 20 mL and 200 mL, for example, about 50 mL. As illustrated in

FIG. 2A, in some implementations, the reaction vessel 202 can have a cylindrical shape positioned vertically with the top opening facing up. The material for the reaction vessel 202 is selected based on the process conditions and chemicals of interest for crystallization testing. For example, some experiments require a corrosive fluid, e.g., hydrogen sulfide (H₂S) and a high pressure, e.g., about 250 psi (1724 kPa) or greater. In some implementations, the reaction vessel 202 can withstand about a pressure of 2500 psi (17237 kPa). Accordingly, the reaction vessel 202 can be metallic. For example, the reaction vessel 202 can include an alloy comprising nickel, chromium, and molybdenum, e.g., HASTELLOY® C-276.

As illustrated in FIG. 2A, the removable cap 204 has a transparent window 206 made of a transparent solid material for Raman signal collection. Accordingly, a Raman probe 112 can be facing toward the transparent window 206 to collect a Raman signal from inside the reaction vessel 202 through the transparent window 206. In this disclosure, a material is considered transparent to a light when at least 90% light transmission is obtained at the wavelength of the light. In some implementations, for the purpose of Raman spectroscopy, the wavelength in the visible and near-infrared regions is used, although other wavelengths may be used. The transparent window 206 can include a glass or other material that is transparent and chemically and thermally stable under the testing conditions.

FIG. 2B is an example a batch reactor 102 included in an advanced crystallization testing (ACT) apparatus without the removal cap 204 illustrated in FIG. 2A. In some implementations, as illustrated in FIG. 2B, the inside the removable cap 204 and a portion 218 of an exterior of the reaction vessel 202 can be threaded to ensure hermetic sealing. Further, a rubber O-ring can optionally be used.

For various crystallization testing experiments, the reaction vessel 202 is coupled to an agitation mechanism 212 to simulate a dynamic condition, e.g., rotation or swaying. The agitation mechanism 212 is configured to agitate contents of the reaction vessel 202. The contents refer to any portion of the substances, e.g., gas, liquid, solid, or any combination thereof, inside the reaction vessel 202. In various implementations, the agitation mechanism 212 agitate the contents by creating motions of the reaction vessel 202 itself. For example, as illustrated in FIG. 2A, the agitation mechanism 212 includes a rod 214 supporting the reaction vessel 202 and a base 216 connected to the rod 214. The base 216 can be a motorized base that creates a rotational movement. This rotational movement can be transferred to the rod 214 and then the reaction vessel 202. In some implementations, the reaction vessel 202 can be rotated at a rate between about 30 rpm and 300 rpm, for example, about 150 rpm. In some implementations, the reaction vessel 202 may be kept static without any agitation for certain conditions of crystallization testing.

In some implementations, the agitation mechanism 212 is capable of internal stirring instead of or in addition to moving the reaction vessel 202 itself. For example, the agitation mechanism 212 can include a magnetic stirrer disposed below the reaction vessel 202 and a magnetic stir bar 220. The magnetic stir bar can be used to stir the content of the reaction vessel 202 without rotating or swaying the reaction vessel 202. Accordingly, in some implementations, the material used to construct the reaction vessel 202 can be selected to be non-magnetic. The ACT apparatus can also be capable of swapping different types of agitation mechanisms depending on the requirements of experiments to be performed.

Further, the reaction vessel 202 can have a sealable inlet port 208 attached to a side of the reaction vessel. For gas introduction to the reaction vessel 202, the sealable inlet port 208 can be connected to a high-pressure gas manifold featuring a series of control and relieve valves. The inlet port 208 can have a valve to seal the reaction vessel 202. In one or more implementations, the inlet port 208 can be connected to a flexible tube for fluid introduction, which can remain connected during the crystallization testing if the agitation is a swaying mode.

In some implementations, a pressure sensing element can be attached to or inserted into the sealable inlet port 208 to measure the pressure inside the reaction vessel 202. A pressure sensor can be attached to the reaction vessel 202. In one or more implementations, the pressure sensor can remain connected during the during the crystallization testing if the agitation is a swaying mode or using magnetic stirring.

As illustrated in FIG. 2A, the reaction vessel 202 can have a secondary port 210. In some implementations, a temperature sensing element can be attached to or inserted into the secondary port 210. A temperature sensor can be attached to the reaction vessel 202. In one or more implementations, the temperature sensor can remain connected during the during the crystallization testing if the agitation is a swaying mode or using magnetic stirring.

Providing individual pressure or temperature sensors for each batch reactor 102 can improve the control of environmental parameters during the crystallization testing and complement Raman-based measurements. With the pressure during the testing monitored, it is also possible to assess crystallization processes using pressure-based measurements.

The design of the batch reactor 102 is only for example, and a batch reactor can have a different shape, size, and configuration in some implementations. Further, the ACT apparatus 100 can have a series of batch reactors 102 with the same design or one or more of the batch reactors 102 can have a different design from the other batch reactors 102.

FIG. 3 is an example of a Raman spectrometer system 110 included in an advanced crystallization testing (ACT) apparatus 100. Like numbered items are as described with respect to FIG. 1 and will not be repeated in detail. Some components such as a stage 116 is omitted in FIG. 3 for illustration purpose.

The Raman spectrometer system 110 includes a computer 108, a light source 302, a spectrometer 304, and a Raman probe 112. The computer 108 is coupled to the other elements of the Raman spectrometer system 110 to enable Raman measurements and analysis. As illustrated in FIG. 3, a light beam, e.g., a laser, is generated in the light source 302. Any appropriate Raman laser source can be used for the light source 302. In some implementations, the laser has a wavelength of 405 nm, 532 nm, 633 nm, 785 nm, 830 nm, 1064 nm, or any combination thereof. The light beam is sent to the Raman probe 112 via a flexible optical cable 306. For example, the flexible optical cable 306 include an optical fiber cable. The light beam is introduced inside a batch reactor 102 of interest through a transparent window 206 and illuminate a sample. A radiation from the illuminated sample containing a Raman signal, which is from inelastic scattering (Raman scattering) is then collected by the Raman probe 112. This collected light is sent via the optical cable 306 to the spectrometer 304 to extract the Raman signal.

In some implementations, a detector is integrated in the spectrometer 304. The detector can include a charged-coupled device (CCD). Further, the CCD can be a CCD camera configured to capture a picture or a video to allow a visual inspection of the inside the reaction vessel 202 in addition to the Raman measurements. Although not specifically illustrated in FIG. 3, the Raman spectrometer system 110 can include any other reasonable components to enable Raman measurements, e.g., one or more lens, filters, beam splitter, and mirrors.

Because Raman spectroscopy provides information of the chemical composition of a sample, it can distinguish between different types of gas hydrate, e.g., CH₄ hydrate from CO₂ hydrate, which help understanding hydrate formation phenomena specific to guest molecules and therefore developing hydrate inhibitors. Different scale types can also be rapidly detected and distinguished. Further, shorter experiments can be expected with Raman spectroscopy for hydrate and scale formation detection compared to other available techniques because of its resolution and ability to detect early stages of crystallization with only small crystals.

In FIG. 3, the Raman spectrometer system 110 is equipped with one Raman spectrometer 304 with one Raman probe 112. As described above referring to FIG. 1, with the Raman moving mechanism 114 together with the flexible optical cable 306, it is possible to switch between multiple samples inside different reactors. Yet in one or more implementation, more than one Raman probe can be used to enable simultaneous Raman measurements.

Although not specifically illustrated in FIGS. 1-3, the ACT apparatus 100 can be combined with other spectroscopic techniques such as Fourier-transform infrared (FTIR) spectroscopy in place or in addition to Raman spectroscopy with appropriate modification to the configuration of the setup. The addition of FTIR spectroscopy can be particularly beneficial in identification of scales.

### Method of Advanced Crystallization Testing (ACT)

In various implementations, the method of performing crystallization testing using the ACT apparatus 100 is for hydrate formation or scale formation. First, one or more reagents, e.g., crystal precursors, can be loaded in one or more batch reactors 102. The reagents can be liquids and gases, but they can include solids, e.g., an inhibitor, to be dissolved in a solution.

In some implementations, for gas hydrate formation, H₂O as a solvent and a gas including guest molecules are used. For example, the volume of the solvent for a batch reactor 102 is between about 20 mL and about 70 mL. The batch reactor 102 can then be charged with the gas, e.g., natural gas, H₂S, and CO₂. In some implementations, the initial pressure of the gas can be between about 15 psi (103 kPa) and about 2500 psi (17237 kPa). Further, one or more hydrate inhibitor can also be used to study the effect of inhibition. The inhibitors can be a kinetic inhibitor, a thermodynamic inhibitor, or both. Examples of the inhibitors include but are not limited to monoethylene glycol, tetrapentylammonium bromide and polyvinylcaprolactam.

For scale formation, the reactants can include acid gases such as H₂S, and CO₂, a solution of interest, e.g., a brine, or both. In one implementation, sodium carbonate can be added to the solution as a salt additive. The inhibitors for scale formation to be used include but are not limited to methylene phosphonic acid ((DETPMP) and phosphino polycarboxylic acid (PPCA).

The batch reactor 102 can be sealed with the removable cap 204 for hermetic sealing and immersed into the bath 104. The bath temperature can be controlled to achieve the target temperature for the experiments, e.g., between −5° C. and 100° C. In some implementations, the gas hydrate formation is performed at a temperature below room temperature, e.g., 0° C. or lower. The scale formation is performed at a temperature between 25° C. and 100° C.

The real-time observation of crystallization can be performed by directing the Raman probe 112 to one of the batch reactors 102 and collecting a Raman signal through the transparent window 206. In some implementations, the Raman probe 112 is also coupled to a CCD camera to capture pictures or videos for visual inspection. The collected Raman signal is sent to the spectrometer 304 and a Raman spectrum can be obtained. Each Raman spectrum can provide certain chemical information of the species in the batch reactors. A series of Raman spectra can be recorded for temporal analysis to obtain kinetic information of the crystallization process.

The method can further include, after completing the Raman measurement from one batch reactor 102, moving the Raman probe 112 to another batch reactor to collect another Raman signal from the newly selected batch reactor. In some implementations, the Raman measurements and moving the Raman probe 112 to a next batch reactor to be measured can be programmed to be performed automatically or digitally controlled with a user command.

FIG. 4 is a flow diagram of a method 400 of crystallization testing using an ACT apparatus according to an implementation. The method 400 starts with loading 402 one or more batch reactors with a crystal precursor, followed by immersing 404 the batch reactors in a bath. A uniform temperature of the immersed batch reactors in the bath is maintained 406 at a set temperature, e.g., about −5° C. A Raman signal is then collected 408 from inside one of the immersed batch reactors to assess the crystallization process such as gas hydrate formation or scale formation. After completing the Raman measurement from the one of the immersed batch reactors, another Raman signal can then be collected 410 from inside another one of the immersed batch reactors.

As described above in various implementations, the ACT apparatus 100 is capable of Raman characterization of solid formation in one or more batch reactors under dynamic conditions with agitation. The ACT apparatus 100 can improve the testing throughput and enable obtaining kinetic information. This will help conduct tendency assessment of both scale and hydrate formation phenomena in a robust manner, while providing more essential data on the formation tendency. In particular, the nucleation stages with small crystals can be assessed, which will further help distinguishing the type of scale/hydrate and designing advanced scale and hydrate inhibitors.

### EXAMPLES

In some implementations, the testing protocol using the ACT apparatus 100 can proceed as follows: adding a solution and reactants of interest to the reactor vessel 202; sealing the reactor vessel 202 by covering with the removable cap 204; immersing the batch reactor 102 in the bath 104; purging the solution inside the batch reactor 102 with nitrogen gas to remove dissolved gases in the solution, e.g., oxygen; introducing the gas of interest to each reactor 102; adjusting the temperature of the cooling/heating fluid inside the bath to the temperature of interest; selecting the mode of agitation, e.g., static, dynamic through the rod for rotating or swaying, or dynamic through internal stirring with a magnetic stir bar 220; monitoring the temperature and pressure inside the bath; and monitoring test conditions using a Raman spectrometer system 110. When rotating the entire batch reactor 102, the gas and temperature lines can be disconnected from the body of the reactor vessel 202.

### Implementations

An implementation described herein provides an apparatus including: a reaction vessel including an open end and a closed end; a removable cap to hermetically seal the open end, the removable cap including a transparent window made of a transparent solid material; a Raman probe facing toward the transparent window and being configured to collect a Raman signal from inside the reaction vessel through the transparent window; an agitation mechanism to agitate contents of the reaction vessel; a bath to house the reaction vessel and maintain a temperature of the reaction vessel at a set temperature.

In an aspect, combinable with any other aspect, the apparatus further includes: another reaction vessel including another open end; another removable cap to hermetically seal the other open end, the other removable cap including another transparent window made of the transparent solid material; and a Raman moving mechanism attached to the Raman probe and configured to move the Raman probe such that the Raman probe faces toward the another transparent window.

In an aspect, combinable with any other aspect, the bath is configured to house the reaction vessel and the other reaction vessel simultaneously.

In an aspect, the Raman moving mechanism is configured to rotate the Raman probe around an axis for any degree between 0 and 360 degrees while keeping a same height distance from the bath.

In an aspect, combinable with any other aspect, the apparatus further includes a pressure sensor attached to the reaction vessel, the pressure sensor configured to measure a pressure inside the reaction vessel.

In an aspect, combinable with any other aspect, the apparatus further includes a temperature sensor attached to the reaction vessel, the temperature sensor configured to measure a temperature inside the reaction vessel.

In an aspect, combinable with any other aspect, the apparatus further includes a sealable inlet port attached to a side of the reaction vessel.

In an aspect, combinable with any other aspect, the apparatus further includes a Raman detector connected to the Raman probe, the Raman detector including a charged-coupled device (CCD) camera configured to capture a video of inside the reaction vessel.

In an aspect, combinable with any other aspect, the reaction vessel includes an alloy including nickel, chromium, and molybdenum.

In an aspect, the agitation mechanism includes: a rod supporting the reaction vessel at the closed end; and a rotation mechanism to rotate the rod and the reaction vessel.

In an aspect, the agitation mechanism includes: a magnetic stirrer; and a magnetic stir bar inside the reaction vessel.

An implementation described herein provides a system of Raman spectroscopy including: multiple batch reactors, each batch reactor including a reaction vessel, a sealable inlet port attached to the reaction vessel, a removable cap to hermetically seal the reaction vessel, the removable cap including a transparent window made of a transparent solid material, and an agitation mechanism configured to agitate contents of the reaction vessel; a Raman probe connected to a Raman detector and a laser source; a probe adjusting mechanism configured to move the Raman probe or the batch reactors such that the Raman probe is faced toward any one of the batch reactors; and a bath to house the batch reactors and maintain a uniform temperature of the batch reactors at a set temperature.

In an aspect, combinable with any other aspect, the agitation mechanism is configured to perform swaying agitation.

In an aspect, combinable with any other aspect, the bath is filled with a heat transfer fluid.

In an aspect, combinable with any other aspect, the bath is configured to hold each batch reactor at a same depth in the heat transfer fluid.

An implementation described herein provides a method of processing, where the method includes: loading multiple batch reactors with a crystal precursor, a solvent, wherein each batch reactor including, a reaction vessel having a cylindrical shape, a removable cap to hermetically seal the reaction vessel, the removable cap including a transparent window made of a transparent solid material; hermetically sealing the multiple batch reactors with the removable cap; immersing the multiple batch reactors into a bath configured to maintain a set temperature; measuring Raman signals using a Raman probe from inside one of the batch reactors through the transparent window, the Raman signals being characteristic of a crystallization process within the one of the batch reactors.

In an aspect, combinable with any other aspect, the method includes agitating the one of the batch reactors while measuring the Raman signals.

In an aspect, the method includes rotating the one of the batch reactors at a rate between 50 rpm and 300 rpm.

In an aspect, the method includes moving the Raman probe to face toward another one of the batch reactors; and measuring Raman signals from inside the other one of the batch reactors.

In an aspect, the solvent includes water, the crystal precursor includes a carbonate, CO₂, or H₂S.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. An apparatus comprising:
a reaction vessel comprising an open end and a closed end;
a removable cap to hermetically seal the open end, the removable cap comprising a transparent window made of a transparent solid material;
a Raman probe facing toward the transparent window and being configured to collect a Raman signal from inside the reaction vessel through the transparent window;
an agitation mechanism to agitate contents of the reaction vessel;
a bath to house the reaction vessel and maintain a temperature of the reaction vessel at a set temperature.

2. The apparatus of claim 1 further comprising:
another reaction vessel comprising another open end;
another removable cap to hermetically seal the another open end, the another removable cap comprising another transparent window made of the transparent solid material; and
a Raman moving mechanism attached to the Raman probe and configured to move the Raman probe such that the Raman probe faces toward the another transparent window.

3. The apparatus of claim 2, wherein the bath is configured to house the reaction vessel and the another reaction vessel simultaneously.

4. The apparatus of claim 2, wherein the Raman moving mechanism is configured to rotate the Raman probe around an axis for any degree between 0 and 360 degrees while keeping a same height distance from the bath.

5. The apparatus of claim 1 further comprising a pressure sensor attached to the reaction vessel, the pressure sensor configured to measure a pressure inside the reaction vessel.

6. The apparatus of claim 1 further comprising a temperature sensor attached to the reaction vessel, the temperature sensor configured to measure a temperature inside the reaction vessel.

7. The apparatus of claim 1, further comprising a sealable inlet port attached to a side of the reaction vessel.

8. The apparatus of claim 1 further comprising a Raman detector connected to the Raman probe, the Raman detector comprising a charged-coupled device (CCD) camera configured to capture a video of inside the reaction vessel.

9. The apparatus of claim 1, wherein the reaction vessel comprises an alloy comprising nickel, chromium, and molybdenum.

10. The apparatus of claim 1, wherein the agitation mechanism comprises:
a rod supporting the reaction vessel at the closed end; and
a rotation mechanism to rotate the rod and the reaction vessel.

11. The apparatus of claim 1, wherein the agitation mechanism comprises:
a magnetic stirrer; and
a magnetic stir bar inside the reaction vessel.

12. A system of Raman spectroscopy comprising:
a plurality of batch reactors, each batch reactor comprising
a reaction vessel,
a sealable inlet port attached to the reaction vessel,
a removable cap to hermetically seal the reaction vessel, the removable cap comprising a transparent window made of a transparent solid material, and
an agitation mechanism configured to agitate contents of the reaction vessel;
a Raman probe connected to a Raman detector and a laser source;
a probe adjusting mechanism configured to move the Raman probe or the plurality of batch reactors such that the Raman probe is faced toward any one of the plurality of batch reactors; and
a bath to house the plurality of batch reactors and maintain a uniform temperature of the plurality of batch reactors at a set temperature.

13. The system of Raman spectroscopy of claim 12, wherein the agitation mechanism is configured to perform swaying agitation.

14. The system of Raman spectroscopy of claim 12, wherein the bath is filled with a heat transfer fluid.

15. The system of Raman spectroscopy of claim 14, wherein the bath is configured to hold each batch reactor at a same depth in the heat transfer fluid.

16. A method of processing, the method comprising:
loading a plurality of batch reactors with a crystal precursor, a solvent, wherein each batch reactor comprising,
a reaction vessel having a cylindrical shape,
a removable cap to hermetically seal the reaction vessel, the removable cap comprising a transparent window made of a transparent solid material;
hermetically sealing the plurality of batch reactors with the removable cap;
immersing the plurality of batch reactors into a bath configured to maintain a set temperature; and
measuring Raman signals using a Raman probe from inside one of the plurality of batch reactors through the transparent window, the Raman signals being characteristic of a crystallization process within the one of the plurality of batch reactors.

17. The method of claim 16, further comprising agitating the one of the plurality of batch reactors while measuring the Raman signals.

18. The method of claim 17, wherein the agitating comprises rotating the one of the plurality of batch reactors at a rate between 50 rpm and 300 rpm.

19. The method of claim 17, further comprising:
moving the Raman probe to face toward another one of the plurality of batch reactors; and
measuring Raman signals from inside the another one of the plurality of batch reactors.

20. The method of claim 17, wherein the solvent comprises water, the crystal precursor comprises a carbonate, CO₂, or H₂S.
